(19) United States
(12) Patent Application Publication
(10) Pub. No.: US 2004/0252951 A1
(43) Pub. Date: Dec. 16, 2004

(54) Optical module and manufacturing method of the same

(75) Inventors: Kimio Nagasaka, Nirasaki-shi (JP); Akira Miyamae, Fujimi-cho (JP); Takeo Kaneko, Misato-mura (JP); Hitoshi Nakayama, Hakushu-cho (JP); Shojiro Kitamura, Fujimi-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/843,617

(22) Filed: May 12, 2004

(30) Foreign Application Priority Data
May 12, 2003 (JP) 2003-133269

(51) Int. Cl. G02B 6/36

(52) U.S. Cl. 385/88; 385/93

(57) ABSTRACT

The invention provides an optical transceiver which can further simplify a manufacturing process. An optical transceiver of the present invention includes: an optical socket to attach an optical plug provided at one end of an optical fiber; a light condensing device to condense light; an electro optical element that emits light according to a supplied electrical signal or generates an electrical signal according to a supplied light reception signal; and a light transmitting substrate supporting the optical socket, the light condensing device, and the electro optical element so that an optical fiber, the light condensing device and the electro optical element are aligned on an optical axis. The optical transceiver has a structure in which an optical waveguide, formed so as to penetrate the substrate in a thickness direction of the substrate and arranged along the optical axis between the light condensing device and the electro optical element, is provided in the above-described substrate, and light advances through the optical waveguide.

### BACKGROUND OF THE INVENTION

1. Field of Invention

The present invention relates to an optical module that performs transmission or reception, or both transmission and reception using an optical fiber as a medium, and a manufacturing method of the same.

2. Description of Related Art

In some cases, an optical fiber is used for Local Area Network (LAN), direct interconnection between computer devices, and interconnection between a computer device and digital audio/video equipment or the like. In these devices, an optical module, which converts an electrical signal into an optical signal to transmit it to an optical fiber and reconverts an optical signal received from the optical fiber into an electrical signal, is used. The optical module includes, for example: a socket into which a plug attached to one end of the optical fiber is inserted; a ball lens arranged between the one end of the optical fiber and an electro optical element, such as a light receiving element and a light emitting element to condense light; and an IC circuit board that converts a parallel signal into a serial signal to drive the electro optical element, and amplifies a light reception signal to convert it from a serial signal into a parallel signal.

A related art manufacturing method of such an optical module is normally as follows: (1) A laser diode (LD) chip is mounted inside of a can package, and the chip is bonded with a lead wire. Furthermore, the ball lens is bonded to an exit window of the can package and the can package with the lens is assembled. (2) The can package is inserted from one side of an insertion hole of the optical socket and a ferrule with a fiber is inserted from the other side of the insertion hole. Current is applied to the lead wire of the can package so as to make LD emit light, and the amount of light coupled to the fiber is measured to bond and fix the can package and the optical socket at a position of the best coupling efficiency (active alignment). (3) The lead wire of the can package is soldered to the circuit board.

Japanese laid-open patent application No. 8-122588 discloses an exemplary related art method.

### SUMMARY OF THE INVENTION

However, in such a manufacturing method of an optical module, three-dimensional complex alignment should be performed when assembling components, and the proportion of manual procedures in the manufacturing process is large. As a result, the cost of a product increases.

Accordingly, the present invention provides a manufacturing method of an optical module that can further simplify the manufacturing process.

In order to address or achieve the above, an optical module of the present invention includes: an optical socket to attach an optical plug provided at one end of an optical fiber; a light condensing device to condense light; an electro optical element, emitting light according to a supplied electrical signal, or generating an electrical signal according to a supplied light reception signal; and a substrate, supporting the optical socket, the light condensing device and the electro optical element so that the optical fiber, the light condensing device and the electro optical element are aligned on one optical axis. The optical module is structured such that an optical waveguide, which is formed so as to penetrate the substrate in a thickness direction of the substrate and arranged along the optical axis between the light condensing device and the electro optical element, is provided in the substrate, and the light advances through the optical waveguide.

By such a structure, the electro optical element, the light condensing device and the optical socket can be combined using the substrate. Furthermore, the optical coupling through the optical waveguide can be attained easily because the precision level of alignment between the electro optical element, the condensing device and the optical socket, which makes most of light emitted from the electro optical element toward the substrate side, or light from the optical fiber toward the substrate side enter the optical waveguide, is not so severe. Therefore, the precision level required for the alignment can be reduced, and facilitation of the manufacturing process and accompanying reduced cost can be achieved. Furthermore, there are other advantages in that the usability of light is enhanced because light leak to the outside of the optical waveguide becomes harder, and that generation of crosstalk due to light leak can be reduced or suppressed as much as possible even when a plurality of electro optical elements are arranged on the substrate to perform multi-channel communication.

Preferably, the electro optical element is arranged on one surface of the substrate, and the light condensing device and the optical socket are arranged at a position corresponding to the electro optical element on the other surface of the substrate. Thereby, the electro optical element, the light condensing device and the optical socket performing transmission and reception can be combined using both surfaces of the substrate and its thickness.

Preferably, the optical waveguide is made of a member having a higher refractive index than a refractive index of a constituting material of the substrate. As for the member, for example, light-curable resin or thermosetting resin is preferably used. Thereby, the optical waveguide having a similar structure to that of the optical fiber or the like can be structured with ease, which simplifies the structure and facilitates the manufacturing.

Preferably, the optical waveguide includes a first member, having a first refractive index, and a second member, having a lower refractive index than the first refractive index and arranged so as to surround a periphery of the first member. More preferably, the optical waveguide is made using either an optical fiber or a bare fiber. Thereby, the optical fiber or the bare fiber is embedded and fixed firmly into the through-hole, and the optical waveguide can be formed. As a result, the manufacturing becomes easier. The optical waveguide may be formed using a light-curable resin or the like for the first and second members.

Preferably, the substrate is a glass substrate excellent in transparency and heat resistance, for example. However, a plastic substrate or the like may be used.

Preferably, the optical socket is joined with the substrate by adhesion, fusion boding, screw cramp, or other ways.

Preferably, the light condensing device is made of any of a refractor, a Fresnel lens, a ball lens (substantially spherical lens) and a Selfoc lens. Thereby, light loss between the electro optical element and the end of the optical fiber can be reduced. In the present specification, “Fresnel lens” indicates a lens that has a cross section of a sawtooth waveform (kinoform) and is formed concentrically so that most of the transmitting light is condensed substantially at one point, and is sometimes referred to as “diffraction grating lens”.

Preferably, the light condensing device is supported by the optical socket. For example, a lens-embedded optical socket is preferably used.

A manufacturing method of an optical module according to the present invention includes: forming a through-hole in a substrate to form an optical waveguide in the through-hole; forming a wiring layer bearing a wiring pattern on one surface of the substrate corresponding to a formation position of the optical waveguide; coupling an electro optical element having a light emitting or light receiving function at a predetermined position of the wiring layer; arranging a lens on the other surface of the substrate; and attaching an optical socket to attach an optical plug holding one end of an optical fiber on the other surface of the substrate.

Furthermore, a manufacturing method of an optical transceiver according to the present invention includes: forming a through-hole in a substrate to form an optical waveguide in the through-hole; forming a wiring layer bearing a wiring pattern on one surface of the substrate corresponding to a formation position of the optical waveguide; coupling an electro optical element having a light emitting or light receiving function at a predetermined position of the wiring layer; and attaching an optical socket, which embeds a lens, to attach an optical plug holding one end of an optical fiber to the other surface of the substrate. The lens embedded in the optical socket is attached inside of the body of the optical socket, or in the vicinity of the end of the body or the like, and bears the function of condensing the light entering the optical fiber or the light emitted from the optical fiber.

By such a structure, the optical transceiver using the substrate can be manufactured.

Furthermore, a manufacturing method of an optical transceiver according to the present invention includes: optical waveguide formation, in which a plurality of through-holes are formed in a substrate to form optical waveguides in each of the through-holes; wiring layer formation, in which wiring layers having unit wiring patterns are formed at a plurality of positions on one surface of the substrate corresponding to each formation positions of the optical waveguides; electro optical element arrangement, in which a plurality of electro optical elements are arranged on the one surface of the substrate corresponding to the unit wiring patterns at the plurality of positions; lens arrangement, in which a plurality of lenses are arranged on the other surface of the substrate corresponding to the plurality of the electro optical elements; optical socket attachment, in which a plurality of optical sockets, each having a fitting hole to attach an optical plug holding one end of an optical fiber, are attached on the other surface of the substrate corresponding to a plurality of pairs of the electro optical element and the lens; and cutting and dividing the substrate into regions including each of the unit wiring patterns.

Furthermore, a manufacturing method of an optical transceiver according to the present invention includes: optical waveguide formation, in which a plurality of through-holes are formed in a substrate to form optical waveguides in each of the through-holes; wiring layer formation, in which wiring layers having unit wiring patterns are formed at a plurality of positions on one surface of the substrate corresponding to each formation positions of the optical waveguides; electro optical element arrangement, in which a plurality of electro optical elements are arranged on the one surface of the substrate corresponding to the unit wiring patterns at the plurality of positions; optical socket attachment, in which a plurality of optical sockets, each having a fitting hole to attach an optical plug holding one end of an optical fiber and embedded with a lens, are attached on the other surface of the substrate corresponding to a plurality of pairs of the electro optical element and the lens; and cutting and dividing the substrate into regions including each of the unit wiring patterns.

By such a structure, a number of optical transceivers are fabricated concurrently on one parent substrate to be cut and divided into each unit of optical transceiver finally, thereby mounting of the element components can be continuously performed at a high speed.

### BRIEF DESCRIPTION OF THE DRAWINGS

FIGS. 1a and 1b are schematics explaining one exemplary embodiment of an optical transceiver of the present invention;

FIGS. 2a and 2b are schematics explaining the section of an optical socket having two terminals;

FIG. 3 is a schematic explaining a coupling state between the optical socket and an optical plug;

FIG. 4 is a schematic explaining the section of an optical socket having one terminal;

FIGS. 5a-5e are schematics explaining a manufacturing process of the optical transceiver;

FIGS. 6a and 6b are schematics explaining arrangement position adjustment of the optical socket in the manufacturing process of the optical transceiver;

FIG. 7 is a schematic explaining a formation example of wiring patterns on a substrate;

FIG. 8 is a schematic explaining an attachment example of the optical socket to the substrate;

FIGS. 9a and 9b are schematics explaining an assembly example by providing attaching holes and attaching projections in the substrate and the optical socket, respectively;

FIG. 10 is a schematic explaining an example of forming the attaching holes in the substrate;

FIG. 11 is a schematic of one exemplary embodiment using a lens-embedded optical socket;

FIG. 12 is a schematic explaining one exemplary embodiment using a lens-embedded optical socket;

FIG. 13 is a schematic explaining an example of an optical transceiver in a comparative example; and

FIG. 14 is a schematic explaining an example of an optical connector in the comparative example.

### DETAILED DESCRIPTION OF PREFERRED EMBODIMENTS

Exemplary embodiments of the present invention are described below with referring to the accompanying drawings.

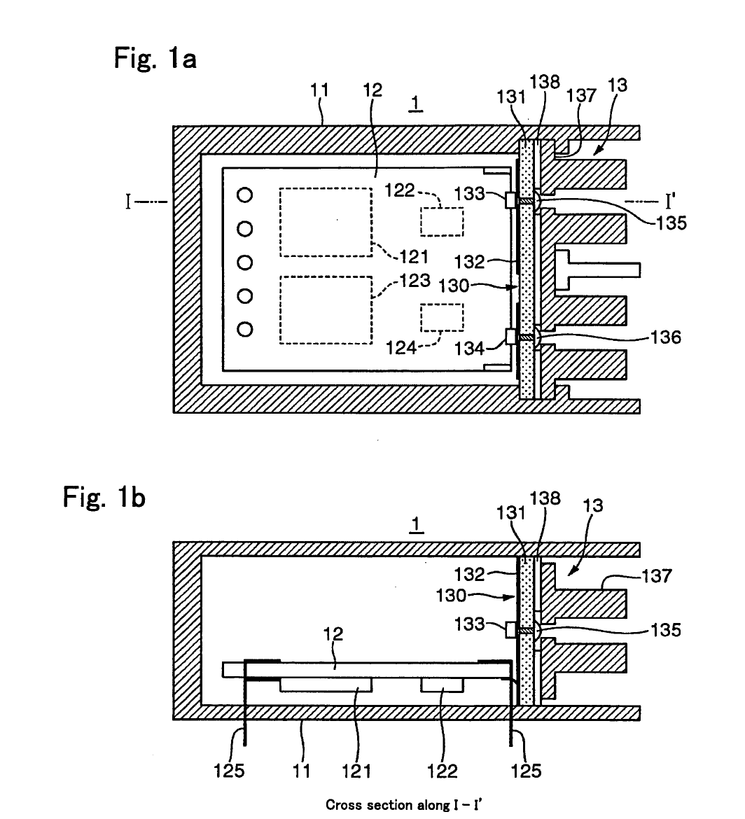

FIGS. 1a and 1b show a structural example of an optical transceiver. FIG. 1a is a cross-sectional view showing an internal arrangement when cutting an optical transceiver 1 in a horizontal direction, and FIG. 1b is a cross-sectional view in a direction of I-I′ in FIG. 1a.

As shown in FIGS. 1a and 1b, inside a housing 11 of the optical transceiver 1, there are provided a signal processing circuit board 12 and an optical coupling unit 13. On the signal processing circuit board 12, there are provided a parallel-serial signal conversion circuit 121 that converts a parallel signal supplied from the outside into a serial signal, a drive circuit 122 that converts the serial signal into a drive signal of a light emitting element 133, an amplifier circuit 124 that shapes a waveform of a light reception signal of a light receiving element 134 and amplifies its level, a serial-parallel signal conversion circuit 123 that converts the light reception signal to a parallel signal, and a lead frame 125 for performing wiring connection and attachment to a mother board (not shown) or the like.

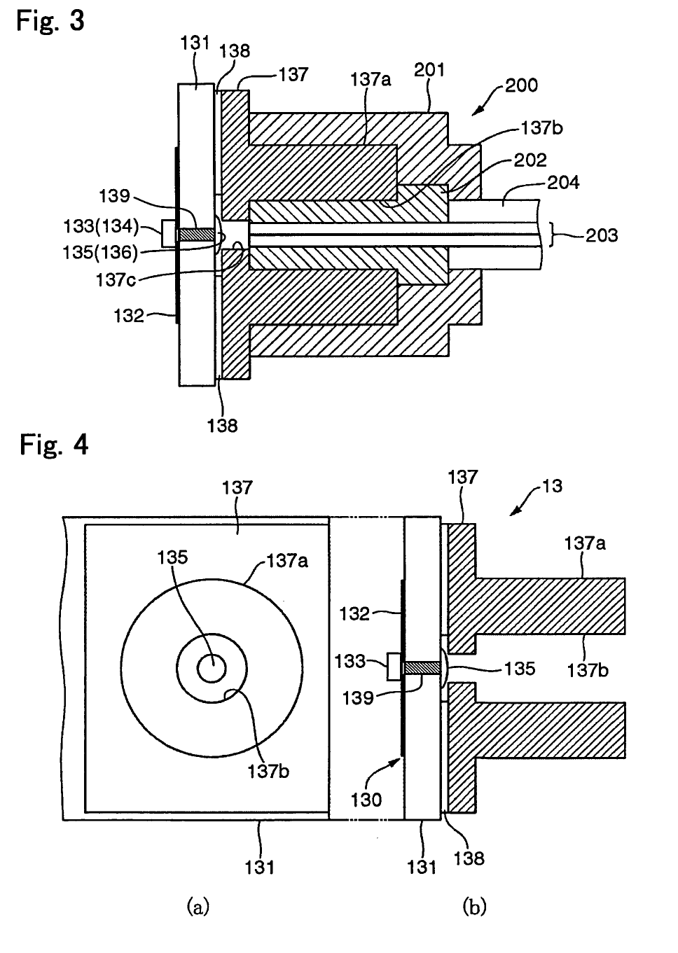

The optical coupling unit 13 includes: an optical circuit board 130, which is structured to arrange a wiring layer 132, the light emitting element 133, the light receiving element 134, coupling lens 135, 136 or the like on a transparent glass substrate 131; an optical socket 137 connected to an optical plug provided at one end of an optical fiber (not shown); and a joining layer 138 attaching the optical socket 137 to the optical circuit board 130. The optical socket 137 (or the optical coupling unit 13) and the optical plug constitute an optical connector (refer to FIG. 3).

Generally, an inserting side is referred to as a plug and an inserted side is referred to as a socket, however, in the description of the present case, one side (optical line side) constituting the connector is referred to as a plug, and the other side (substrate side) is referred to as a socket, both of which are irrelevant with male or female shape.

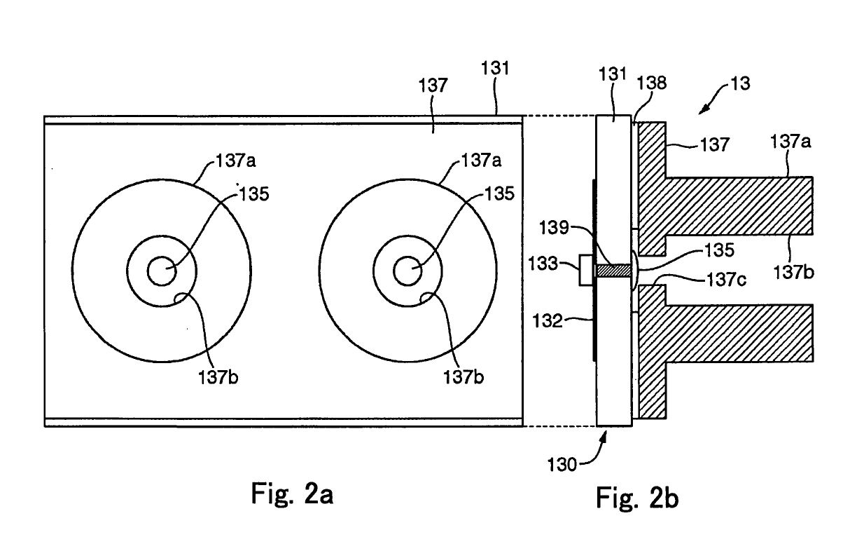

FIGS. 2a and 2b show an enlarged section of the optical coupling unit 13 shown in FIG. 1a. FIG. 2a is a schematic viewing the optical coupling unit 13 from a plug insertion hole. FIG. 2b is a cross-sectional view of the optical coupling unit 13. In the respective figures, the same signs and numerals are given to portions corresponding to FIG. 1, and descriptions of these portions are omitted.

The optical circuit board 130 includes the transparent substrate 131 which allows an optical signal to transmit, the wiring pattern 132 formed on an inside surface of the transparent substrate 131 (inner side of the housing), the light emitting element 133 connected to the wiring pattern 132 (or the light receiving element 134), the coupling lens 135 arranged on an outside surface of the transparent substrate 131 (optical plug side), and an optical waveguide 139 formed so as to penetrate the transparent substrate 131 corresponding to an arrangement position of the light emitting element 133.

The light emitting element 133 is, for example, a Vertical Cavity Surface-Emitting Laser (VCSEL) that generates laser beam. The light receiving element 134 (refer to FIG. 1a) is a light detecting element that generates current according to the amount of received light of a phototransistor, photodiode or the like. A sleeve 137a of the optical socket 137, into which a ferrule (refer to FIG. 3 described below) holding the optical fiber of the optical plug is inserted, is formed into an annular or cylindrical shapes. At a bottom center of a fitting hole 137b of the sleeve 137a to guide the insertion of the ferrule, there is provided an opening 137c. The coupling lens 135 (or 136) formed on the substrate 131 is exposed at the opening 137c. The fitting hole 137b is a hole penetrating the optical socket 137.

The optical waveguide 139 is formed so as to penetrate the transparent substrate 131 in a thickness direction of the transparent substrate 131, and arranged along an optical axis between the coupling lens 135 and the light emitting element 133 (or the light receiving element 134). The optical waveguide 139 is made of a member having a higher refractive index than a refractive index of a constituting material of the transparent substrate 131. For example, light-curable resin or thermosetting resin is preferably used. In addition, through the optical waveguide 139, light emitted from the light emitting element 133 advances to the optical socket 137 side, or light emitted from the optical fiber advances to the light receiving element 134 side.

FIG. 3 shows a state in which an optical plug 200 is attached to the optical socket 137. A columnar ferrule 202 of the optical plug 200 is inserted into the cylindrical sleeve 137a of the optical socket 137, and the ferrule 202 is protected by a plug housing 201. The optical socket 137 and the optical plug 200 are fixed by a locking device (not shown). The locking device, for example, is an openable and closable hook provided in the plug housing 201 and a stud provided in the optical socket 137, with which the hook is engaged. The ferrule 202 holds an end of an optical fiber 203 and is inserted in the cylinder of the sleeve 137a to thereby hold a central axis (optical axis) of the optical fiber 203 on a central axis of the cylinder. A line part of the optical fiber 203 is protected by a covering 204. Light irradiated from a core of the optical fiber 203 is converged (or condensed) on the light receiving element 134 through the coupling lens 136 provided at the opening 137c at the bottom of the sleeve 137a and the optical waveguide 139 provided in the transparent substrate 131. Furthermore, light emitted from the light emitting element 133 is converged on a core part, which is on the end of the optical fiber 203, through the optical waveguide 139 provided in the transparent substrate 131 and the coupling lens 135.

FIG. 4 shows an example of another optical coupling unit (optical connector) 13. In FIG. 4, the same signs and numerals are given to portions corresponding to those in FIG. 2 and descriptions of these portions are omitted. In the above-described example shown in FIG. 2, separate optical fibers are used for transmission and for reception, and two optical fibers are connected to one optical connector. In the example shown in FIG. 4, one optical coupling unit (optical connector) is provided to each fiber for transmission or for reception, or for transmission and reception.

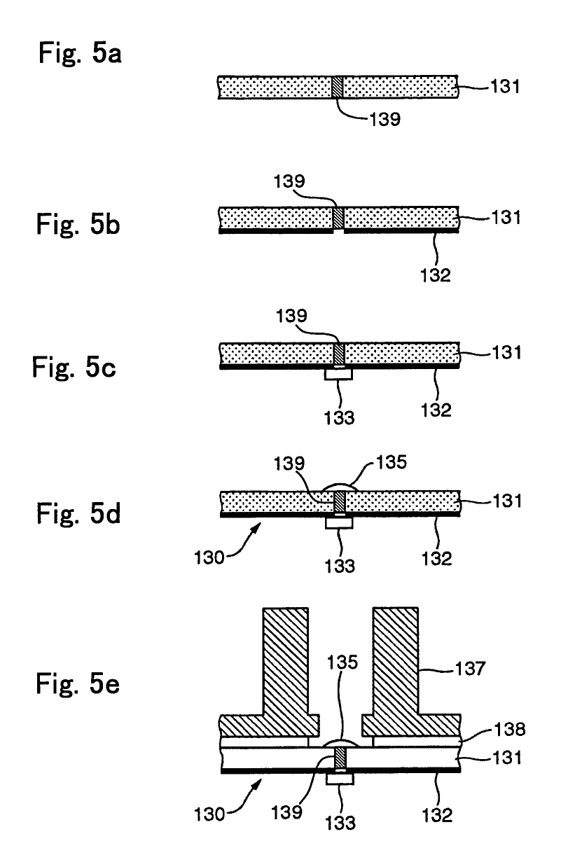

Next, a manufacturing method of the above-described optical transceiver is described with referring to the drawings. FIGS. 5a-5e show steps explaining a manufacturing process of the optical transceiver of the exemplary embodiment.

Firstly, in order to make the optical circuit board 130, the glass substrate 131 is prepared as a light transmitting substrate, as shown in FIG. 5a. Then, a through-hole is formed in the glass substrate 131 corresponding to a formation position of the wiring layer described later, and the optical waveguide 139 is formed in the through-hole. For example, according to the present exemplary embodiment, an ultraviolet-curable resin is filled into the through-hole of the glass substrate 131 and cured to form the optical waveguide 139.

Next, as shown in FIG. 5b, a conductive material, such as aluminum and copper, is deposited on the surface of the glass substrate 131 by sputtering method, electroforming or the like to form a metal layer (conductive layer). The metal layer is subjected to patterning corresponding to a desired circuit to form the wiring layer 132. The order of the step shown in FIG. 5a and the step shown in FIG. 5b may be reversed.

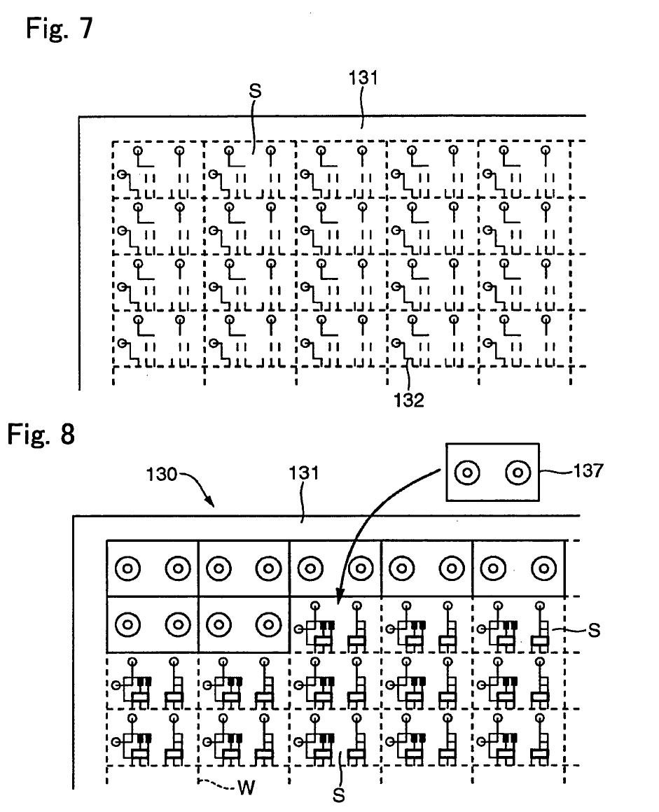

FIG. 7 shows an example, in which each of a plurality of metal wiring layer patterns 132 are formed in each of a plurality of sub-regions S of the glass substrate 131. In the above-described step shown in FIG. 5a, it is more preferable in view of mass production to concurrently form the wiring layers having the unit wiring patterns at a plurality of positions on one surface of the glass substrate 131, as shown in FIG. 7. In this case, corresponding to the unit wiring patterns at the plurality of positions, a plurality of through-holes are formed in the glass substrate 131, and a plurality of optical waveguides 139 are formed in each of the through-holes.

Next, as shown in FIG. 5c, a circuit element, such as the light emitting element 133 (or the light receiving element 134) and integrated circuit, is mounted on the one surface side of the glass substrate 131. The mounting can be performed using flip-chip bonding, wire bonding, solder reflow or the like. As shown in FIG. 7, when the unit wiring patterns are concurrently formed at the plurality of positions of the glass substrate 131, corresponding to each of the unit wiring patterns, a plurality of electro optical elements (the light emitting elements 133 or the light receiving elements 134) are arranged on the one surface of the glass substrate 131 in the step shown in FIG. 5c.

Next, as shown in FIG. 5d, the coupling lens 135 (or 136) is formed at a position corresponding to the light emitting element 133 (or the light receiving element 134) on the other side of the glass substrate 131. The formation of the coupling lens 135 (or 136) can be performed by sticking a lenticular member, lens formation using surface tension of curable type liquid resin, furthermore, lens formation of combining lens type and 2P process, or the like. In this way, the optical circuit board 130 is made. As described above in FIG. 7, when the unit wiring patterns are concurrently formed at the plurality of positions of the glass substrate 131, corresponding to the plurality of the electro optical elements, each of the plurality of lenses 135 (or 136) are arranged on the other surface of the glass substrate 131 in the step shown in FIG. 5d.

Next, as shown in FIG. 5e, the optical socket 137 is attached to the optical circuit board 130. The attachment is performed such that an adhesive is applied to surfaces of the optical socket 137 and the glass substrate 131 facing each other, or to either of the surfaces to attach the optical socket 137 to the optical circuit board 130. The optical socket 137 is placed on the optical circuit board 130 so that the central axis of the cylindrical fitting hole 137b of the sleeve 137a of the optical socket 137 substantially coincides with a center position of the coupling lens 135 (or 136) and the light emitting element 133 (or 134). The alignment (rough adjustment) of the optical socket 137 and the optical circuit board 130 at this step can be performed referring to a marker (not shown) of the board 130, a lens position or the like.

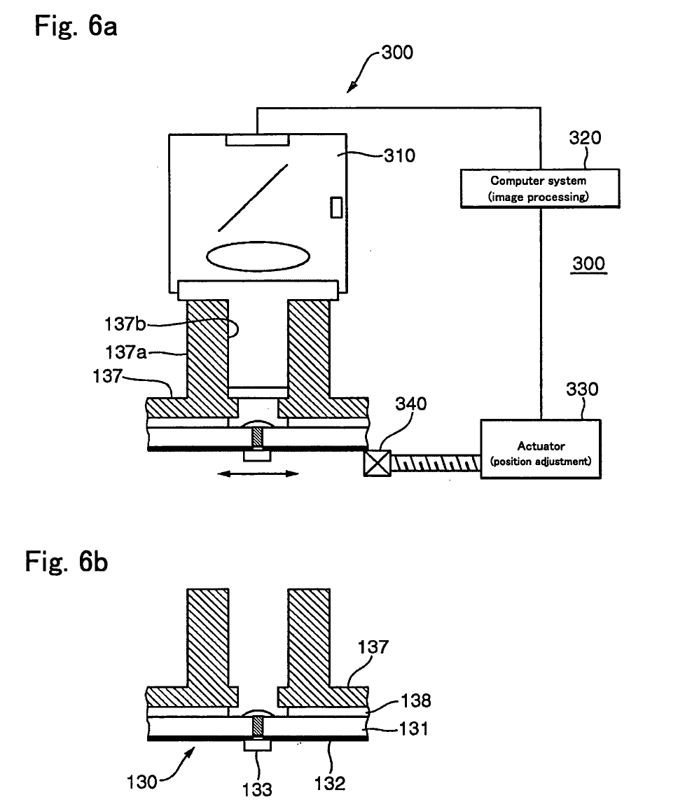

Furthermore, as shown in FIG. 6a, precise alignment between the optical socket 137 and the optical circuit board 130 is performed.

FIGS. 6a and 6b show one example of a preferable position adjustment device performing precise alignment between the optical socket 137 and the optical circuit board 130. For example, a position adjustment device 300 shown in FIG. 6 is used for the precise alignment. The position adjustment device 300 includes: an optical head 310 reading an alignment mark described below and an object body; a computer system 320 detecting a position displacement between the alignment mark and the object body by image processing; an actuator 330 driven so as to compensate the position displacement by the computer system 320; and an arm (stage), attached to the actuator and transfers the glass substrate 131 or the optical head 310 to an attachment position. The optical head 310 inserts the ferrule (a reading unit) into the fitting hole 137b of the optical socket 137 and reads the alignment mark indicating a center position of the fitting hole 137b, and the object body, such as a predetermined circuit pattern of the substrate and a mark for adjustment. Based on this result, the alignment (fine adjustment) is performed so that the central axis of the fitting hole 137b of the optical socket 137 and the center position (optical axis) of the coupling lens 135 and the electro optical element 133 (or the coupling lens 136 and the electro optical element 134) precisely coincide with each other. When the optical plug 200 is loaded on the optical socket 137, the core of the optical fiber 203 supported by the ferrule 202 is located on the central axis of the fitting hole 137b.

As shown in FIG. 6b, after the alignment between the optical socket 137 and the optical circuit board 130 is completed, the adhesive 138 is solidified to fix the optical socket 137 on the optical circuit board 130. As for the adhesive 138, for example, light-curable or thermosetting resin or the like can be used.

The steps of FIGS. 5e, 6a and 6b are repeated for required times and the optical sockets 137 are attached to the plurality of sub-regions S of the optical circuit board 130 to assemble the optical transceivers as shown in FIG. 8. The board 130 assembled in this way is cut along a cutting line W for each of the sub-regions S to obtain a number of optical transceivers.

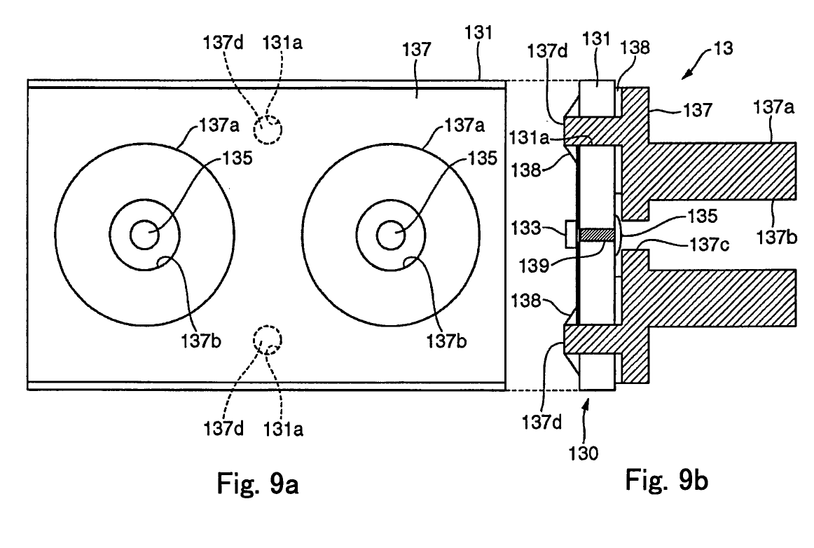

FIGS. 9a and 9b show another exemplary embodiment. FIG. 9a is a schematic viewing the optical coupling unit part 13 of the exemplary embodiment from the insertion opening side of the optical plug. FIG. 9b is a cross-sectional view of the optical coupling unit 13. In both of these views, the same signs and numerals are given to portions corresponding to those of FIGS. 2a and 2b, and descriptions of these portions are omitted.

In the exemplary embodiment, attachment strength between the optical socket 137 and the optical circuit board 130 is enhanced. Furthermore, assembly is made easier while attachment precision of the optical socket 137 to the optical circuit board 130 is secured.

Therefore, in the exemplary embodiment, as shown in FIGS. 9a and 9b, projections (guide pins) 137d are formed in, at least, two positions of the optical socket 137. The guide pins 137d are inserted into guide holes 131a formed in the glass substrate 130 corresponding to the guide pins 137d.

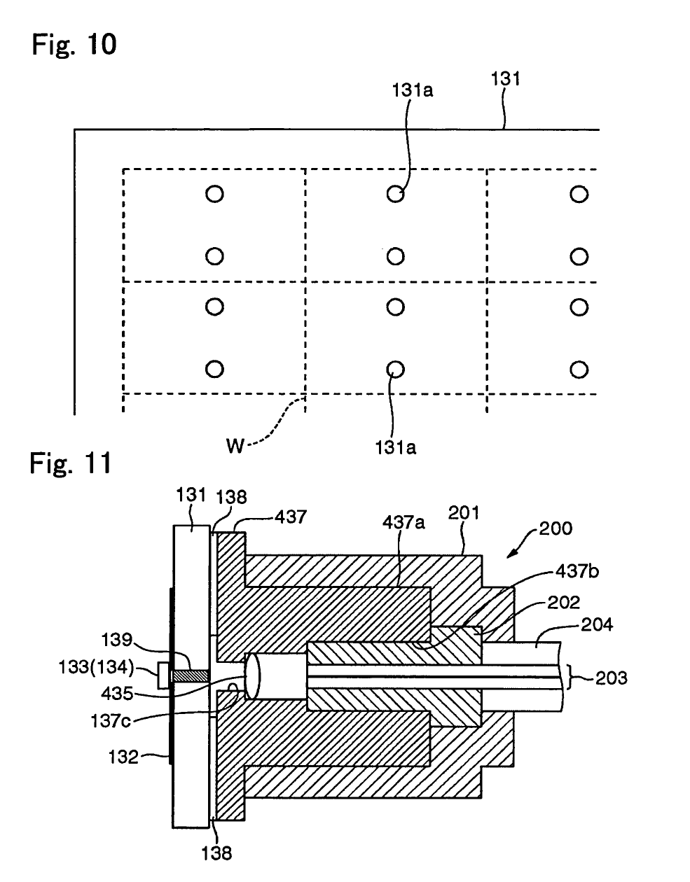

As for the assembling step of the exemplary embodiment, as shown in FIG. 10, the guide holes 131a, having a predetermined diameter, are formed on the glass substrate 131 in advance at predetermined positions by photo lithography or the like with high precision. The electro optical element and the coupling lens can be attached also at a predetermined position based on the guide holes 131a. On the glass substrate 131, the wiring pattern 132 is formed, and components are loaded, subsequently, the optical socket 137 is attached.

As for the optical socket 137, the guide pins 137d, having a predetermined depth, are formed precisely at predetermined positions based on the center of the guide hole 131a. The guide pins 137d of the optical socket 137 are fitted into the guide holes 131 a of the glass substrate 131 to attach the socket 137 to the glass substrate 131. Furthermore, by bonding the guide pins 137d and the glass substrate 131 with the adhesive 138, both of them are fixed firmly.

Alternatively, an optical transceiver can be structured by using an optical socket embedded with a coupling lens.

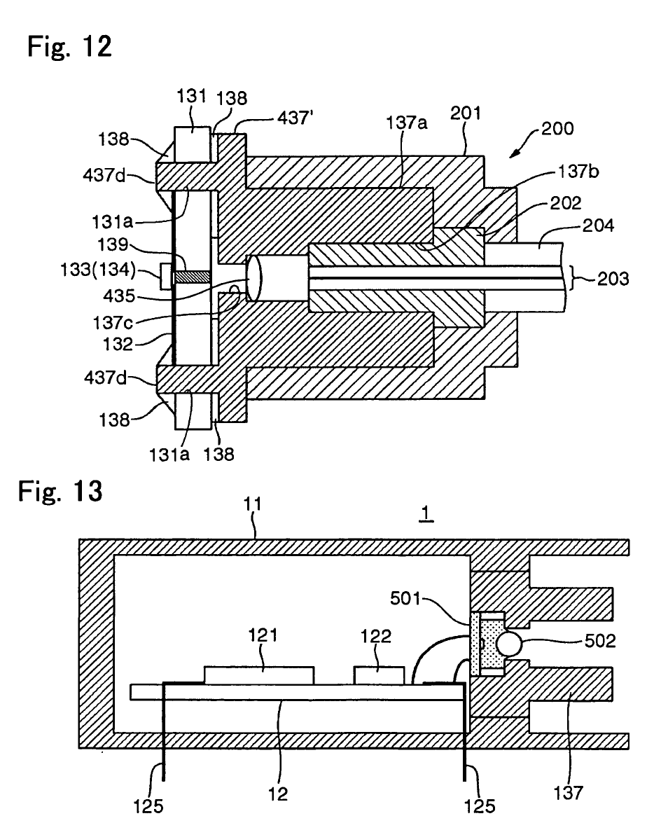

FIGS. 11 and 12 show an exemplary embodiment using a lens-embedded optical socket. FIGS. 11 and 12 show a state in which the optical plug 200 is attached to the lens-embedded optical socket 437. In both of these figures, the same signs and numerals are given to portions corresponding to those in FIG. 3, and descriptions of these are omitted.

The optical socket 437 shown in FIG. 11 embeds a coupling lens 435. Then, in the exemplary embodiment shown in FIG. 11, the coupling lens 135, arranged on the inner surface of the glass substrate (transparent substrate) 131 in the above-described exemplary embodiments, is omitted.

The cylindrical ferrule 202 of the optical plug 200 is inserted into a cylindrical sleeve 437a of the optical socket 437, and the ferrule 202 is protected by the plug housing 201. The optical socket 437 and the optical plug 200 are fixed by a locking device (not shown). The locking device, for example, is an openable and closable hook provided in the plug housing 201 and a stud provided in the optical socket 437, with which the hook is engaged. Light irradiated from the core of the optical fiber 203 is converged (or condensed) on the light receiving element 134 through the coupling lens 435 embedded in the sleeve 437a, and the glass substrate 131. Furthermore, light emitted from the light emitting element 133 is converged on the core part at the end of the optical fiber 203 through the glass substrate 131 and the coupling lens 435. As for the coupling lens 435, a substantially spherical lens (ball lens) may be used.

An optical socket 437′ shown in FIG. 12 has a similar structure to that of the above-described optical socket 437 shown in FIG. 11, however, the optical socket 437′ is different in that guide pins 437d are formed in at least two positions. The guide pins 437d are inserted into guide holes 131a, formed in the glass substrate 130 corresponding to the guide pins 437d. In the exemplary embodiment, similarly to the above-described exemplary embodiment described in FIGS. 9a, 9b, and other figures, attachment strength between the optical socket 437 and the optical circuit board 130 can be enhanced. Furthermore, assembly can be made easier while attachment precision of the optical socket 437 to the optical circuit board 130 is secured.

The manufacturing processes of the optical transceiver using the optical socket 437 shown in FIG. 11 or the optical socket 437′ shown in FIG. 12 are basically similar to that in the above-described exemplary embodiment in FIGS. 5a-5e and other figures, however, the manufacturing process can be simplified because the coupling lens 135 does not need to be formed on the glass substrate 131.

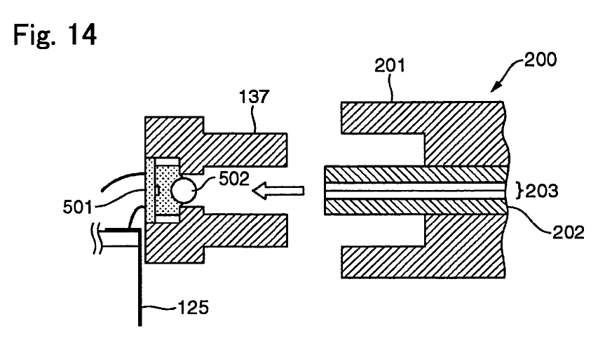

To explain advantages of the present invention, FIGS. 13 and 14 show an optical transceiver of a comparative example. FIG. 13 shows a cross-sectional view of a housing of the optical transceiver of the comparative example. The same signs and numerals are given to portions corresponding to those of FIG. 1(b), and descriptions of these portions are omitted.

Also in the comparative example, an electrical signal is supplied from the outside to a circuit board 12 through a lead flame 125. On the circuit board 12, a parallel-serial signal conversion circuit 121, a driving circuit 122 driving a laser diode, or the like are mounted. The laser diode is mounted inside of a metal can package 501. A beam, emitted from the laser diode is condensed by a ball lens 502 attached to a window of the can package 501, is condensed on the central portion of the insertion hole of the sleeve of the optical socket 137.

FIG. 14 shows an optical connector of the comparative example. The ferrule 202, fixing the optical fiber 203 at the center of the optical plug 200, is inserted into the central portion of the optical plug 200. When the optical plug 200 is connected to the socket 137, light condensed by the ball lens 502 enters the center of the core of the optical fiber 203.

In such a structure of the comparative example, steps of attachment of a laser diode chip to the inside of the can package 501, bonding between the chip and a lead wire, adhesion of the ball lens to the can package window, and assembly of the can package with the lens, and other steps are required. Furthermore, the can package is inserted from one side of a hole of the sleeve of the socket, while the ferrule supporting the fiber is inserted from the other side of the hole of the sleeve of the socket, and the can package and the sleeve are bonded to be fixed at a position where the light, emitting from the laser diode, is transmitted most efficiently. Thereafter, the lead wire of the can package is soldered to the circuit board to complete the steps.

Because the optical transceiver of the comparative example having such a structure has a three-dimensional structure, a complex alignment should be performed when assembling the components. In contrast, according to the exemplary embodiments of the present invention, because the optical transceiver is formed using the light transmitting substrate, the assembly can be performed by substantially two-dimensional alignment, which is advantageous.

As described above, according to the exemplary embodiments of the present invention, the optical coupling unit of the optical transceiver can be attained by the structure, in which the wiring and the electro optical element are arranged on the one surface side of the transparent substrate, and the coupling lens and the sleeve are arranged on the other surface side of the substrate. By taking such a structure, a number of sets of wiring pattern and coupling lens are formed on one piece of substrate and these are cut out into sub-substrates to manufacture the optical coupling units, which is appropriate for a process of mass production. Furthermore, the optical coupling through the optical waveguide can be attained easily because the precision level of alignment between the electro optical element, the condensing device and the optical socket, which makes most of light emitted from the electro optical element toward the substrate side, or light from the optical fiber toward the substrate side enter the optical waveguide, is not so severe. Therefore, the precision level required for the alignment can be reduced, and facilitation of the manufacturing process and accompanying reduced cost can be achieved.

Furthermore, there are other advantages in that the usability of light is improved because light leak to the outside of the optical waveguide becomes harder, and that generation of crosstalk due to light leak can be reduced or suppressed as much as possible, even when a plurality of electro optical elements are arranged on the substrate to perform multi-channel communication.

Furthermore, positions of the sleeve and the lens before fixing firmly can be manually or automatically moved two-dimensionally so that the ferrule alignment mark of the position adjustment device coincides with the alignment mark of the substrate, and such an adjustment is easy to handle and appropriate for automation.

Furthermore, mounting of the elements and the sleeves can be continuously performed at a high speed while sliding the glass substrate.

Furthermore, inspection of the respective temporary coupled units, output adjustment of the Vertical Cavity Surface-Emitting Laser (VCSEL), and sensitivity adjustment of the light emitting diode (PD) are enabled while sliding the glass substrate.

Furthermore, as for the adjustment method using the optical head of the exemplary embodiment, by taking an image using a CCD image pickup device, for example, relative positional relationship between the ferrule alignment mark and the alignment mark on the light emitting element or the light receiving element can be precisely detected by image processing, thereby high speed positioning can be attained by reducing the number of loops of position detection and movement.

In this way, as compared with the related art method for mounting and assembling parts individually, cost can be largely reduced.

The present invention is not limited to the above-described exemplary embodiments, and various modified embodiments are possible within the scope of the claims of the present invention. For example, in the above-described exemplary embodiments, the optical waveguide 139 is structured by filling the resin having a higher refractive index than that of the constituting material of the substrate 131 into the through-hole provided in the substrate 131, however, the optical waveguide can be structured in another method.

Specifically, in the through-hole provided in the substrate 131, an optical waveguide, made of a first member having a first refractive index, and a second member, having a lower refractive index than the first refractive index and arranged so as to surround a periphery of the first member, can be arranged. Such an optical waveguide can be realized by forming the first and second members using light-curable resin or the like. More preferably, by fixing a prepared optical fiber, bare fiber or the like into the through-hole after embedding, the optical waveguide can be formed in a simpler and more convenient way.

What is claimed is:

1. An optical module for use with an optical fiber and an optical plug provided at one end of the optical fiber, the optical module comprising:
an optical socket to attach to the optical plug;
a light condensing device to condense light;
an electro optical element, emitting light according to a supplied electrical signal, or generating an electrical signal according to a supplied light reception signal;
a substrate, supporting the optical socket, the light condensing device and the electro optical element so that the optical fiber, the light condensing device and the electro optical element are aligned on one optical axis; and
an optical waveguide formed so as to penetrate the substrate in a thickness direction of the substrate and arranged along the optical axis between the light condensing device and the electro optical element, the optical waveguide being provided in the substrate, the light advancing through the optical waveguide.

2. The optical module according to the claim 1, the electro optical element being arranged on one surface of the substrate, and the light condensing device and the optical socket being arranged at a position corresponding to the electro optical element on the other surface of the substrate.

3. The optical module according to the claim 1, the substrate being a light transmitting substrate.

4. The optical module according to the claim 3, the optical waveguide being formed by a member having a higher refractive index than a refractive index of a constituting material of the substrate.

5. The optical module according to the claim 3, the optical waveguide including a first member, having a first refractive index, and a second member, having a lower refractive index than the first refractive index and arranged so as to surround a periphery of the first member.

6. The optical module according to the claim 5, the optical waveguide being formed by at least one of an optical fiber and a bare fiber.

7. The optical module according to the claim 3, the substrate being a glass substrate.

8. The optical module according to the claim 1, the optical socket being joined with the substrate.

9. The optical module according to the claim 1, the light condensing device being formed by at least one of a refractor, a Fresnel lens, a ball lens and a Selfoc lens.

10. The optical module according to the claim 9, the light condensing device being supported by the optical socket.

11. A manufacturing method of an optical module, comprising:
forming a portion having a through-hole in a light transmitting substrate to form an optical waveguide in the through-hole;
forming a wiring layer bearing a wiring pattern on one surface of the substrate corresponding to a formation position of the optical waveguide;
coupling an electro optical element having a light emitting or light receiving function at a predetermined position of the wiring layer;
arranging a lens on another surface of the substrate; and
attaching an optical socket to attach an optical plug holding one end of an optical fiber on the other surface of the substrate.

12. A manufacturing method of an optical module, comprising:
forming a portion having a through-hole in a light transmitting substrate to form an optical waveguide in the through-hole;
forming a wiring layer bearing a wiring pattern on one surface of the substrate corresponding to a formation position of the optical waveguide;
coupling an electro optical element having a light emitting or light receiving function at a predetermined position of the wiring layer; and
attaching an optical socket, embedded with a lens, to attach an optical plug holding one end of an optical fiber to another surface of the substrate.

13. A manufacturing method of an optical module, comprising:
forming a optical waveguide, in which a plurality of portions having through-holes are formed in a substrate to form optical waveguides in each of the through-holes;
forming a wiring layer, in which wiring layers having unit wiring patterns are formed at a plurality of positions on one surface of the substrate corresponding to formation positions of the optical waveguides;
arranging an electro optical element, in which a plurality of electro optical elements are arranged on the one surface of the substrate corresponding to the unit wiring patterns at the plurality of positions;
arranging a lens, in which a plurality of lenses are arranged on another surface of the substrate corresponding to the plurality of the electro optical elements;
attaching an optical socket, in which a plurality of optical sockets, each having a fitting hole to attach an optical plug holding one end of an optical fiber, are attached on the other surface of the substrate corresponding to a plurality of pairs of the electro optical element and the lens; and
cutting and dividing the substrate into regions including each of the unit wiring patterns.

14. A manufacturing method of an optical module, comprising:
forming an optical waveguide, in which a plurality of through-holes are formed in a substrate to form optical waveguides in each of the through-holes;
forming a wiring layer, in which wiring layers having unit wiring patterns are formed at a plurality of positions on one surface of the substrate corresponding to formation positions of the optical waveguides;
arranging an electro optical element, in which a plurality of electro optical elements are arranged on the one surface of the substrate corresponding to the unit wiring patterns at the plurality of positions;
attaching an optical socket, in which a plurality of optical sockets, each having a fitting hole to attach an optical plug holding one end of an optical fiber and embedded with a lens, are attached on another surface of the substrate corresponding to a plurality of pairs of the electro optical element and the lens; and
cutting and dividing the substrate into regions including each of the unit wiring patterns.
